(19) United States
(12) Patent Application Publication
(10) Pub. No.: US 2008/0174254 A1
(43) Pub. Date: Jul. 24, 2008

(54) Controlling Lighting in a Digital Video Stream

(76) Inventors: Michael Negley Abernethy, Pflugerville, TX (US); Kulvir Singh Bhogal, Fort Worth, TX (US); Travis M. Grigsby, Austin, TX (US); Alexandre Polozoff, Bloomington, IL (US)

Correspondence Address: IBM CORPORATION- AUSTIN (JVL);C/O VAN LEEUWEN & VAN LEEUWEN, PO BOX 90609, AUSTIN, TX, 78709-0609, US

(21) Appl. No.: 12/049,289

(22) Filed: Mar. 15, 2008

Related U.S. Application Data
(63) Continuation of application No. 11/340,450, filed on Jan. 26, 2006.

(51) Int. Cl. H05B 37/02

(52) U.S. Cl. 315/307

(57) ABSTRACT

An approach for controlling lighting in a digital video stream is presented. A user loads digital content into a light tracking system. The digital content includes three tracks, which are a video track, an audio track, and a light control track. After loading, the user selects either a “partial light effect setting” or a “full light effect setting.” When the user selects a partial light effect setting, the light tracking system lowers the environmental lighting device's illumination at the beginning of the digital content's playing, and raises the environmental lighting device's illumination at the end of the digital content's playing. When the user selects a full light effect setting, the light tracking system adjusts the environmental lighting device's illumination throughout the digital content's playback, as well as lowering and raising the environmental lighting device's illumination at the beginning and the end of the movie, respectively.

### RELATED APPLICATIONS

This application is a continuation application of co-pending U.S. Non-Provisional patent application Ser. No. 11/340,450, entitled “System and Method for Controlling Lighting in a Digital Video Stream,” filed on Jan. 26, 2006.

### BACKGROUND OF THE INVENTION

1. Technical Field

The present invention relates to a system and method for controlling lighting in a digital video stream. More particularly, the present invention relates to a system and method for analyzing light change identifiers corresponding to digital content light changes, and manipulating environmental lighting based upon the light change identifiers.

2. Description of the Related Art

Digital content technology, such as digital versatile disc (DVD) technology, has evolved over the years that allows a user to experience enhanced video and audio effects within the comfort of the user's home. For example, a DVD includes a video track with a high definition video signal that produces high definition images on a display. In addition, the DVD includes an audio track that provides a high quality audio signal. When used with a home entertainment system, the user is able to reproduce a “movie theater” experience at home.

A challenge found, however, is providing the user with an even more realistic experience in order to immerse the user into the digital content. Today's technologies continue to improve the user's video experience and audio experience, but do not address the issue of improving the user's “environmental” experience. For example, when a user watches a movie that includes a lightning storm, the user views the storm on a television screen and hears the storm through speakers, but the user's environment (e.g., living room) does not change to simulate the lightning storm.

What is needed, therefore, is a system and method for manipulating a user's environment based upon digital content.

### SUMMARY

It has been discovered that the aforementioned challenges are resolved using a system and method for analyzing light change identifiers corresponding to digital content light changes, and manipulating environmental lighting based upon the light change identifiers. A user enters an environment (e.g., living room) and loads the digital content into a light tracking system. The digital content includes three “tracks,” which are a video track, an audio track, and a light control track. For example, the digital content may be a digital versatile disc (DVD) that includes a movie. In this example, the video track includes the video portion of the movie, the audio track includes the audio portion of the movie, and the light control track includes light change identifiers corresponding to scene changes in the video track, such as the beginning of the movie, candlelight scenes, intense light scenes, and the end of the movie.

The user's environment includes the light tracking system, a lighting control, an environmental lighting device (e.g., lamp), and may also include a light kit control and a light kit. The light tracking system instructs the lighting control to illuminate the environmental lighting device at particular levels during the digital content's playback. For example, the lighting control may include dimmer circuitry that controls the amount of voltage provided to the environmental lighting device that is received from an electrical outlet. When applicable, the light tracking system instructs the light kit control as to which lights to illuminate on the light kit (e.g., red, green, blue, etc.), such as while viewing a music concert.

Once the user loads the digital content into the light tracking system, the light tracking system displays menus for the user to configure the light control settings. The user selects either a “partial light effect setting” or a “full light effect setting.” When the user selects a partial light effect setting, the light tracking system monitors light change identifiers included in the digital content and instructs the lighting control to lower the environmental lighting device's illumination at the beginning of the digital content's playing, and raise the environmental lighting device's illumination at the end of the digital content's playing.

When the user selects a full light effect setting, the light tracking system monitors the light change identifiers included in the digital content and instructs the lighting control to adjust the environmental lighting device's illumination throughout the digital content's playback, as well as lowering and raising the environmental lighting device's illumination at the beginning and the end of the movie, respectively. For example, when the digital content includes a “torch-lit cave” scene, the light tracking system may instruct the lighting control to barely illuminate the environmental lighting device in order to simulate the torch-lit scene in the user's living room.

In one embodiment, a sensor is placed in proximity to a display and, as the video content is displayed on the display, the sensor detects the video content's light changes. In turn, the sensor provides corresponding light intensity values to the light tracking system. The light tracking system converts the light intensity values to light change identifiers and processes the light change identifiers accordingly.

The foregoing is a summary and thus contains, by necessity, simplifications, generalizations, and omissions of detail; consequently, those skilled in the art will appreciate that the summary is illustrative only and is not intended to be in any way limiting. Other aspects, inventive features, and advantages of the present invention, as defined solely by the claims, will become apparent in the non-limiting detailed description set forth below.

### BRIEF DESCRIPTION OF THE DRAWINGS

The present invention may be better understood, and its numerous objects, features, and advantages made apparent to those skilled in the art by referencing the accompanying drawings.

FIG. 1 is a diagram showing a light tracking system that monitors a light control track that is included in a digital content stream, and adjusts environmental lighting accordingly;

FIG. 2 is a diagram showing a light tracking system connected to a light kit control and lighting control;

FIG. 3A is a user menu that allows a user to configure a light tracking system;

FIG. 3B is a user menu that allows a user to configure a light tracking system;

FIG. 4 is a diagram showing a light tracking system using a monitor sensor to control environmental lighting;

FIG. 5A is a diagram showing a digital content stream that includes a light control track;

FIG. 5B is a table showing light change values;

FIG. 6 is a flowchart showing steps taken in a user configuring a light tracking system;

FIG. 7 is a flowchart showing steps taken in a light tracking system controlling environmental lighting based upon digital content;

FIG. 8 is a flowchart showing steps taken in converting a sensor's light intensity values to light change identifiers that are processed by a light tracking system; and

FIG. 9 is a block diagram of a computing device capable of implementing the present invention.

### DETAILED DESCRIPTION

The following is intended to provide a detailed description of an example of the invention and should not be taken to be limiting of the invention itself. Rather, any number of variations may fall within the scope of the invention, which is defined in the claims following the description.

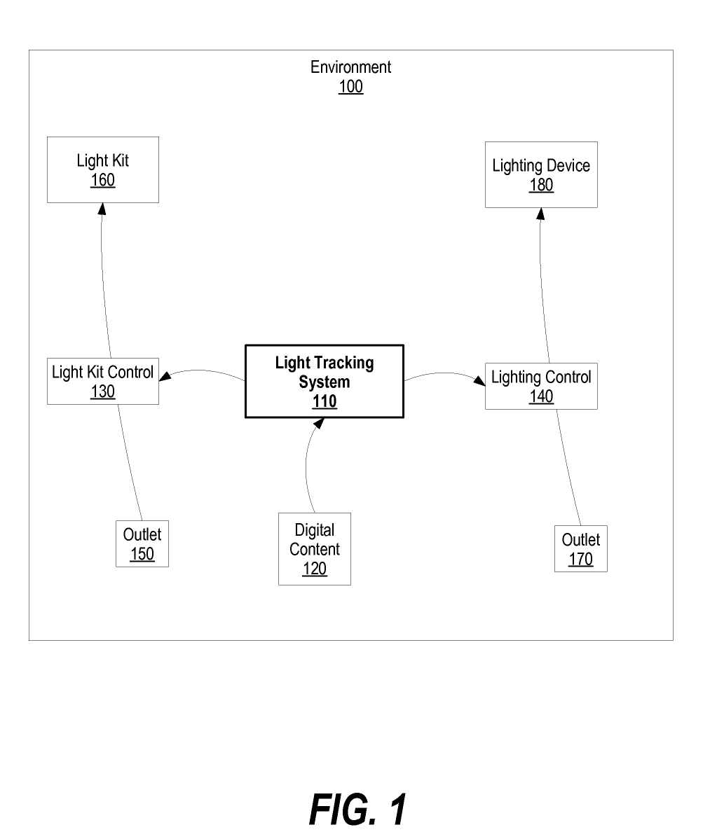

FIG. 1 is a diagram showing a light tracking system that monitors a light control track that is included in a digital content stream, and adjusts environmental lighting accordingly. A user configures light tracking system 110 to manipulate environmental lighting (i.e. room lighting) in order to enhance the user's digital content viewing experience. For example, when a user views a movie, light tracking system 110 may lower the living room lights at the beginning of the movie and raise the living room lights at the end of the movie. In addition, the user may configure light tracking system 110 to manipulate the environmental lighting throughout the movie or manipulate an external light kit's illumination for added effects, such as when viewing a concert.

Environment 100 includes light tracking system 110, electrical outlets 150 and 170, light kit control 130, light kit 160, lighting control 140, and lighting device 180. Lighting control 140 receives signals from light tracking system 110, which instructs lighting control 140 to illuminate lighting device 180 at particular levels during digital content 120's playback. For example, lighting control 140 may include dimmer circuitry that controls the amount of voltage provided to lighting device 180 that is received from electrical outlet 170. Light kit control 130 receives signals from light tracking system 110 that indicates which lights are illuminated in light kit 160 (e.g., red, green, blue, etc.).

A user enters environment 100 and loads digital content 120 into light tracking system 110. Digital content 120 includes three “tracks,” which are a video track, an audio track, and a light control track. For example, digital content 120 may be a digital versatile disc (DVD) that includes a movie. In this example, the video track includes the video portion of the movie, the audio track includes the audio portion of the movie, and the light control track includes light change identifiers corresponding to scene changes in the video track, such as the beginning of the movie, candlelight scenes, intense light scenes, and the end of the movie.

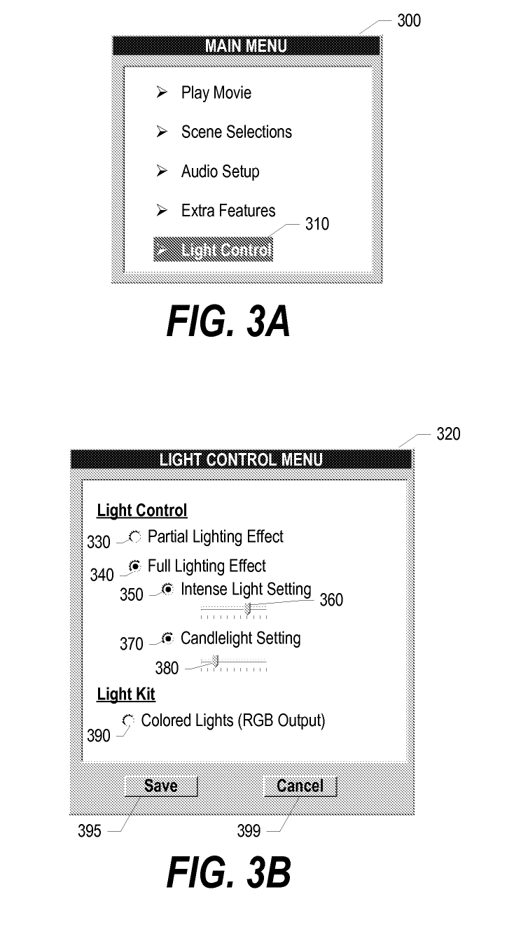

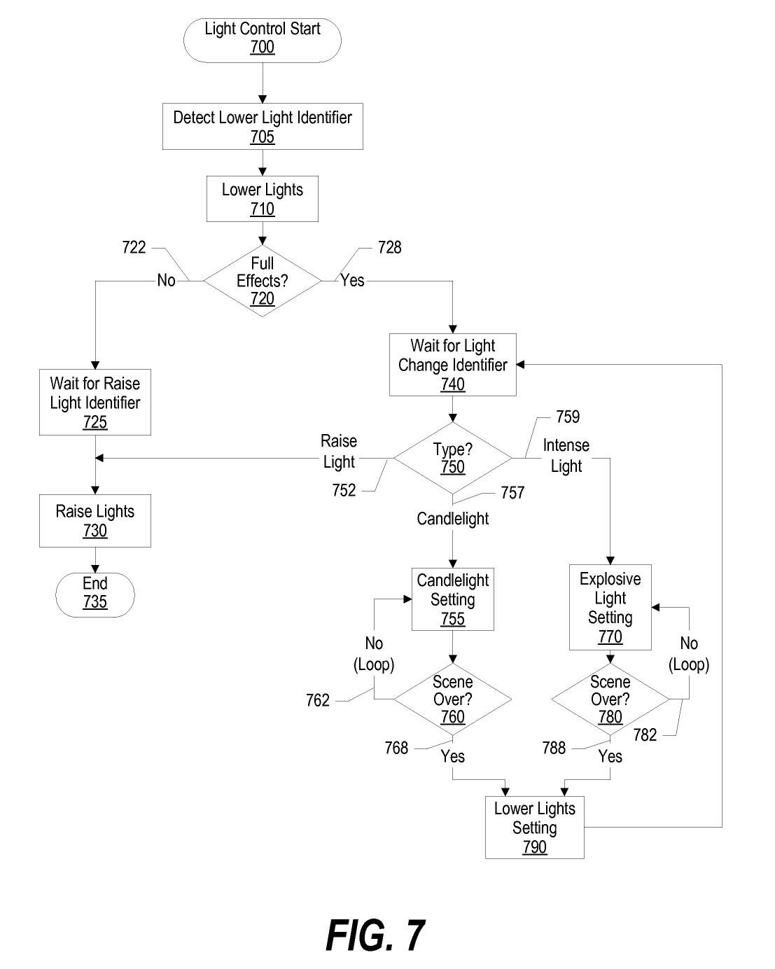

Once the user loads digital content 120 into light tracking system 110, light tracking system 110 displays menus for the user to select light control configuration settings, such as those shown in FIGS. 3A and 3B. The user is able to select either a partial light effect setting or a full light effect setting. When the user selects a partial light effect setting, light tracking system 110 monitors light change identifiers included in digital content 120 and instructs lighting control 140 to lower lighting device 180's illumination at the beginning of digital content 120's playing, and raise lighting device 180's illumination at the end of digital content 120's playing. When the user selects a full light effect setting, light tracking system 110 monitors the light change identifiers included in digital content 120 and instructs lighting control 140 to adjust lighting device 180's illumination throughout digital content 120's playback in addition to lowering and raising lighting device 180's illumination at the beginning and the end of the movie, respectively. For example, when digital content 120 includes a “torch-lit cave” scene, light tracking system 110 may instruct lighting control 140 to barely illuminate lighting device 180 in order to simulate the torch-lit scene in environment 100 (see FIG. 7 and corresponding text for further details).

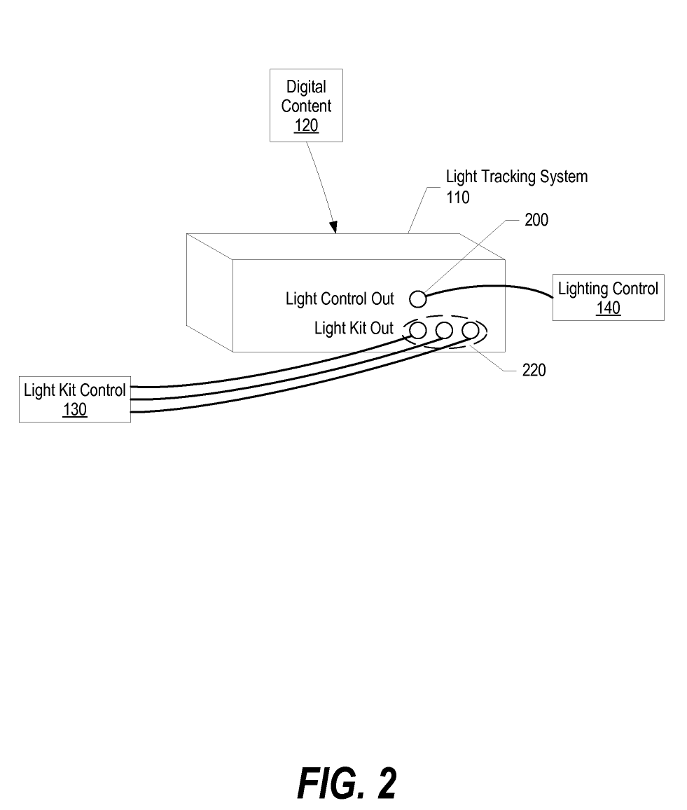

FIG. 2 is a diagram showing a light tracking system connected to a light kit control and a lighting control. FIG. 2 shows light tracking system 110's output ports 200 and 220, which connect to lighting control 140 and light kit control 130, respectively. When a user loads digital content into light tracking system 110, light tracking system 110 monitors a light control track for light change identifiers and provides signals on ports 200 and 220, which instruct lighting control 140 and light kit control to adjust the illumination of lights that are connected. Light tracking system 110, digital content 120, lighting control 140, and light kit control 130 are the same as that shown in FIG. 1.

FIG. 3A is a user menu that allows a user to configure a light tracking system. A user inserts digital media into a system, which prompts the system to display menu 300. For example, a user may insert a DVD into a DVD player that includes a light tracking system. In turn, the DVD player displays menu 300 on a television screen for the user to change configuration settings or play the movie.

When the user wishes to set light control configuration settings, the user selects “light control” 310 using a remote control device. In turn, the system displays a light control configuration menu that allows the user to select light control options (see FIG. 3B and corresponding text for further details).

FIG. 3B is a user menu that allows a user to configure a light tracking system. Light control configuration menu 320 allows a user to configure light control settings for particular digital content. In one embodiment, a user may configure light control settings and a light tracking system uses the same configuration settings for each digital content until the user changes the configuration settings.

A user is able to select either a partial light effect setting (command button 330) or a full light effect setting (command button 340). A partial light effect setting lowers environmental lights at the beginning of the digital content, and raises the environmental lights at the end of the digital content. A full light effect setting adjusts the environmental lights throughout the digital content playing in addition to lowering and raising the lights at the beginning and the end of the movie, respectively.

When a user selects full light effect setting command button 340, the user is able to select intense light command button 350 and/or candlelight setting command button 370. By selecting command button 350, the light tracking system adjusts the lights according to scroll bar 360's setting each time the light tracking system detects an intense light indicator (e.g., a lightning storm in a movie). By selecting command button 370, the light tracking system adjusts the lights according to scroll bar 380's setting each time the light tracking system detects a candlelight indicator (e.g., a torch-lit cave in a movie).

The user may also connect a light kit to the light tracking system in order to simulate a particular digital content atmosphere, such as a concert. As such, the user may select command button 390, which activates color outputs on the light control system that drive the light kit to illuminate red, green, and/or blue lights when the light tracking system detects respective light change identifiers. The user selects command button 395 to save the user's changes, or selects command button 399 to cancel the user's changes.

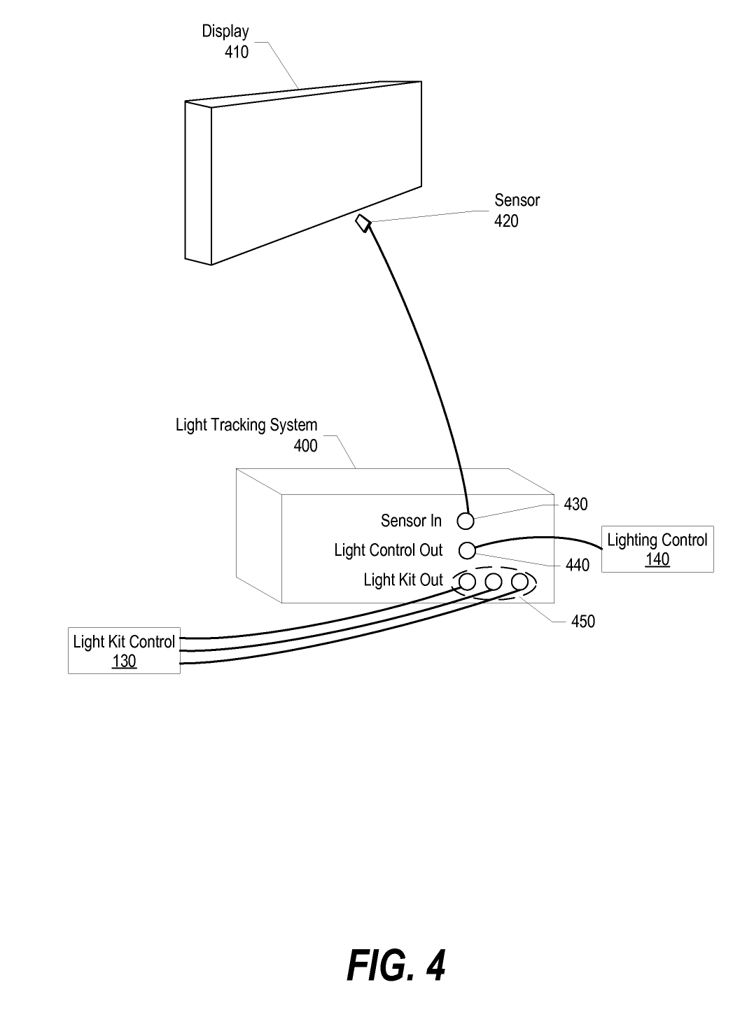

FIG. 4 is a diagram showing a light tracking system using a monitor sensor to control environmental lighting. In the embodiment shown in FIG. 4, sensor 420 is placed in proximity to display 410. As video content is displayed on display 410, sensor 420 detects the video content's light changes and, in turn, sensor 420 provides corresponding light intensity values to light tracking system 400 through port 430. For example, display 410 may show a lightning storm and, in this example, sensor 420 provides high light intensity values to light tracking system 400.

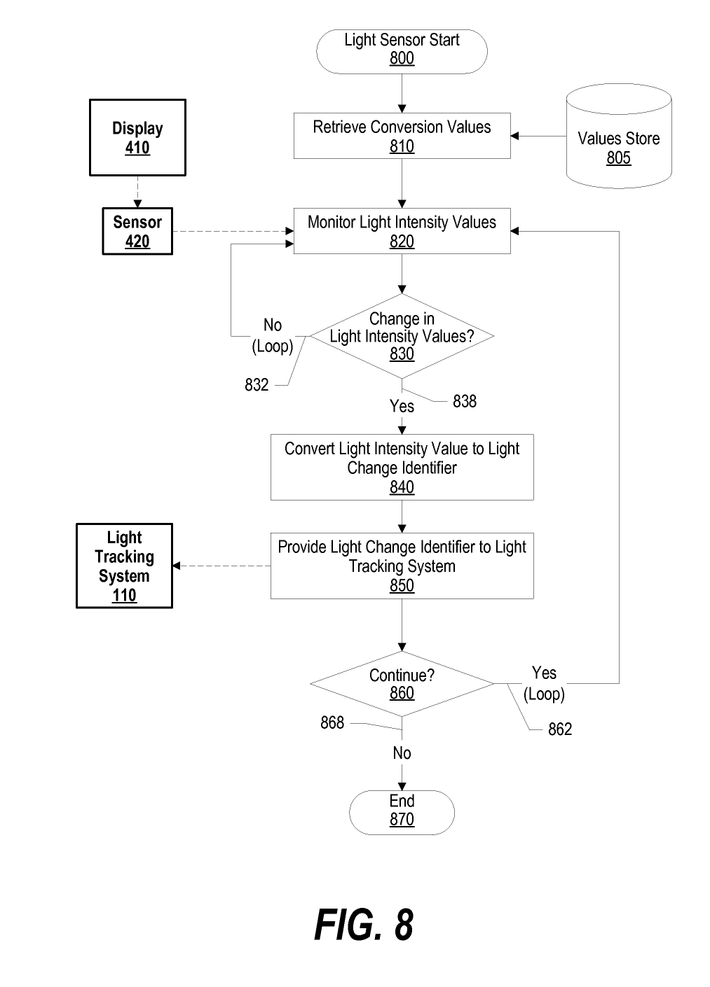

Light tracking system 400 receives the light intensity values and converts them to light change identifiers (see FIG. 8 and corresponding text for further details). As a result, light tracking system 400 provides signals on ports 440 and 450, which instruct lighting control 140 and light kit control to adjust the illumination of lights that are connected as discussed in FIGS. 1 and 2. Light control 140 and light kit control 130 are the same as that shown in FIG. 1.

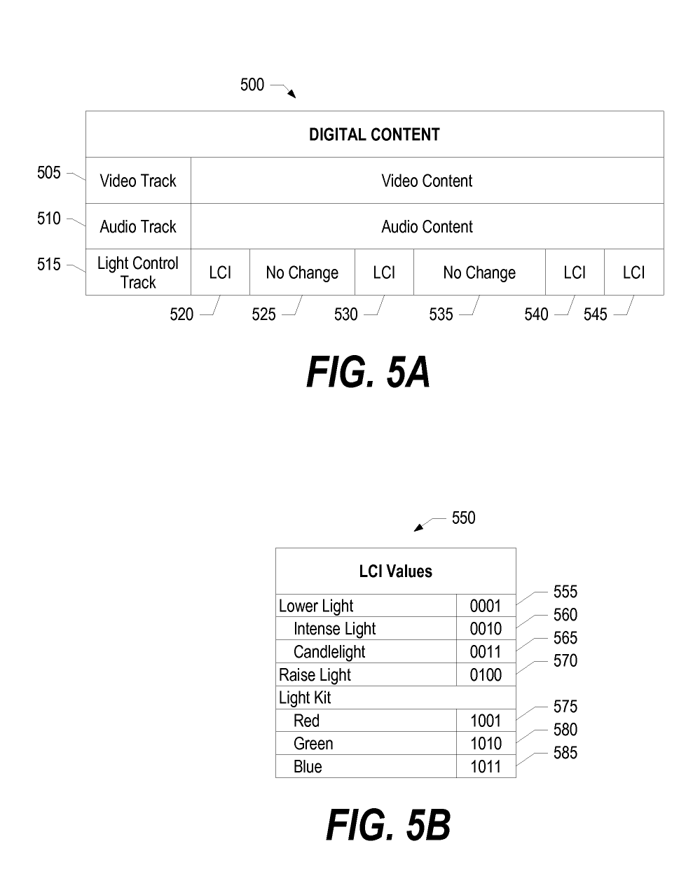

FIG. 5A is a diagram showing a digital content stream that includes a light control track. Digital content 500 includes three “tracks,” which are video track 505, audio track 510, and light control track 515. For example, digital content 500 may be extracted from a digital versatile disc (DVD) that includes a movie. In this example, video track 505 includes the video portion of the movie, audio track 510 includes the audio portion of the movie, and light control track 515 includes light change identifiers corresponding to scene changes in video track 505, such as the beginning of the movie and the end of the movie.

Light control track 515 includes light change identifiers (LCI) 520, 530, 540, and 545. Light change identifier 520 may be a “lower light identifier” that signifies the beginning of the digital content. As such, a light tracking system detects light change identifier 520 and lowers environmental lighting. Light change identifiers 530 and 540 may be “candlelight identifiers” or “intense light identifiers.” As such the light tracking system adjusts the environmental lighting accordingly. Light change identifier 545 may be a “raise light identifier” signifying the end of digital content 500. As such, the light tracking system may raise the environmental lights when the light tracking system detects light change identifier 545. During sections 525 and 535, video content 505 does not include scenes corresponding to changes in light and, therefore, the light tracking system returns the environmental lights to the lower light setting.

FIG. 5B is a table showing light change values. A light tracking system may distinguish light change identifiers using values that are shown in table 550. Table 550 includes rows 555 through 570, which correspond to four basic light change identifiers. Row 555 shows that when a light change identifier has the value “0001,” the light change identifier is a lower light identifier. Row 560 shows that when a light change identifier has the value “0010,” the light change identifier is an intense light identifier. Row 565 shows that when a light change identifier has the value “0011,” the light change identifier is a candlelight identifier. And, row 570 shows that when a light change identifier has the value “0100,” the light change identifier is a raise light identifier.

Table 550 also includes light change identifiers 575-585 that correspond to a light kit, such as light kit 160 shown in FIG. 1. For example, a user may purchase a light kit, which flashes red, green, and/or blue lights to simulate a concert that is being viewed from a DVD. Row 575 shows that when a light change identifier has the value “1001,” the light change identifier corresponds to lighting a red light on a light kit. Row 580 shows that when a light change identifier has the value “1010,” the light change identifier corresponds to lighting a green light on a light kit. And row 585 shows that when a light change identifier has the value “1011,” the light change identifier corresponds to lighting a blue light on a light kit. As one skilled in the art can appreciate, other light change values may be used to instruct a light tracking system to illuminate a combination of lights at the same time.

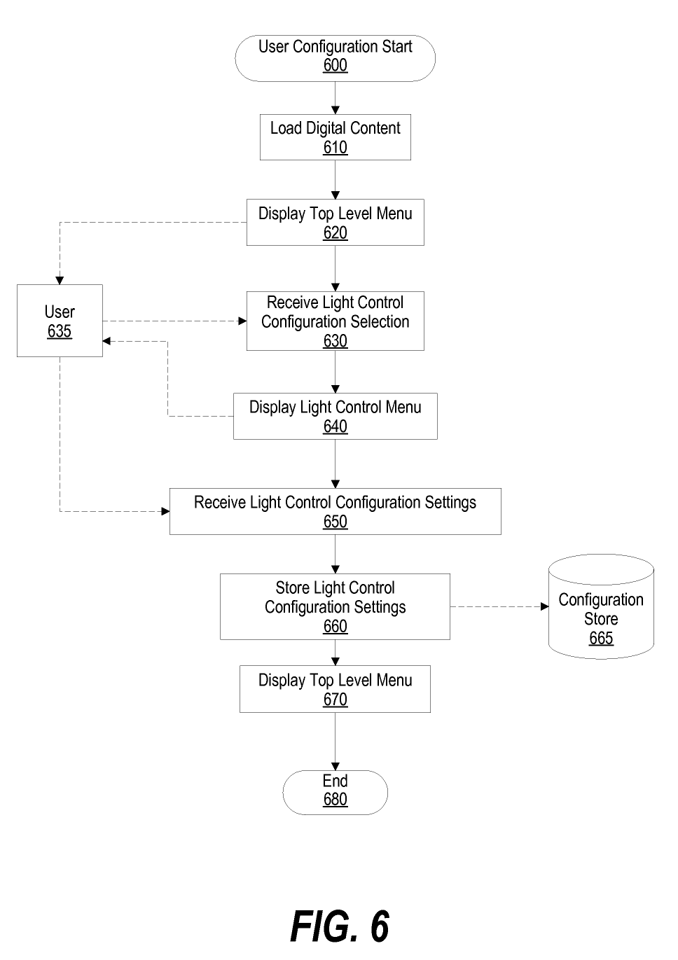

FIG. 6 is a flowchart showing steps taken in a user configuring a light tracking system. A user configures the light tracking system in order for the light tracking system to control environmental lighting based upon digital content. For example, the user may wish to watch a horror movie and configure the light tracking system to flash the user's living room lights each time that the horror movie shows lightning or an explosion. In another example, the user may wish to view a concert. In this example, the user may purchase a light kit and configure the light tracking system to flash red, green, and/or blue lights to simulate the concert that is being viewed from a DVD.

User configuration processing commences at 600, whereupon processing loads the digital content, such as a digital versatile disc (DVD) (step 610). At step 620, processing displays a top-level menu to user 635. The top-level menu includes a selection to configure the “light control,” and may also include selections for playing a movie, audio configuration setup, etc. (see FIG. 3A and corresponding text for further details).

User 635 views the top-level menu and selects the “light control” configuration option, which processing receives at 630. At step 640, processing displays a light control menu that allows the user to select a partial lighting effect setting or a full lighting effect setting, as well as a light kit control setting. For example, the user selects a partial lighting effect setting when the user wants the light tracking system to turn down the living room lights when the movie starts, and turn up the living room lights when the movie ends. In another example, the user selects a full lighting effect setting when the user wants the light tracking system to, in addition to turning down and up the lights, flicker the lights during a lightning scene, and/or dim the lights during a candlelight scene (see FIG. 3B and corresponding text for further details). In addition, the light tracking system may be configured to turn up the lights when the user pauses a movie, and returns the lights to their light intensity prior to the pausing when the user resumes the movie. Furthermore, the light tracking system may be configured to raise the lights slightly when the user fast-forwards or rewinds the movie.

At step 650, processing receives user 635's light control configuration settings and, at step 660, processing stores the light control configuration settings in configuration store 665 for use during the digital content playback (see FIG. 7 and corresponding text for further details). Configuration store 665 may be stored on a nonvolatile storage area, such as a computer hard drive. Once the light control configuration settings are stored, processing displays the top-level menu to user 635 once again so user 635 may play the digital content (step 670). User configuration processing ends at 680.

FIG. 7 is a flowchart showing steps taken in a light tracking system controlling environmental lighting based upon digital content. A user configured the light tracking system to control environmental lights (e.g., living room lights) based upon digital content, such as a DVD. Once configured, the user plays the digital content and the light tracking system monitors a light control track on the digital content for light changes (see FIG. 5A and corresponding text for further details). The flowchart shown in FIG. 7 assumes that the user configured either partial light control or full light control. If the user does not configure either partial light control or full light control, the light track system may stay idle during the digital content playback.

Processing commences at 700, whereupon processing detects a light change identifier that is a lower light identifier, which indicates the start of the digital content (step 705). As a result, processing lowers the environmental lights at step 710. For example, the light tracking system may include outputs that are connected to a lighting control or a light control kit, such as that shown in FIG. 1. In this example, processing sends a signal to the lighting control and/or the light kit control to dim the lights that are connected.

A determination is made as to whether the user selected a partial lighting effect setting or a full lighting effect setting (decision 720). If the user selected a partial lighting effect setting, decision 720 branches to “No” branch 722 whereupon processing waits for a light change identifier that is a “raise light identifier,” which corresponds to the end of the digital content (step 725). When processing detects the raise light identifier, processing raises the lights at step 730, and processing ends at 735.

On the other hand, if the user selected a full lighting effect setting, decision 720 branches to “Yes” branch 728 whereupon processing waits for another light change identifier at step 740. When processing detects another light change identifier, a determination is made as to the type of the light change identifier (decision 750). If the light change identifier is a candlelight identifier, decision 750 branches to “Candlelight” branch 757 whereupon processing sets one or more lighting controls to a candlelight setting, such as simulating a cave lit by torches (step 755). A determination is made as to whether the scene is over (e.g., actors leaving the cave) (decision 760). If the scene is not over, decision 760 branches to “No” branch 762 which loops back to continue to set the lighting controls to the candlelight setting. This looping continues until the scene is complete, whereupon decision 760 branches to “Yes” branch 768 whereupon processing sets the light controls back to the lower light setting (step 790) and loops back to wait for more light change identifiers.

When the light change identifier is an intense light identifier, decision 750 branches to “Intense Light” branch 759 whereupon processing sets one or more lighting controls to an intense light setting, such as simulating a lightning strike or an explosion (step 770). A determination is made as to whether the scene is over (e.g., explosion finished) (decision 780). If the scene is not over, decision 780 branches to “No” branch 782 which loops back to continue to set the lighting controls to the intense light setting. This looping continues until the scene is complete, whereupon decision 780 branches to “Yes” branch 788 whereupon processing sets the light controls back to the lower light setting (step 790) and wait for more light change identifiers.

When processing detects that a light change identifier is a raise light identifier, decision 752 branches to “Raise Light” branch 752 whereupon processing sets the lighting controls to the raise lights settings (step 730), and processing ends at 735.

In one embodiment, a sensor that detects light changes on a display is connected to the light tracking system. In this embodiment, the sensor may provide “light intensity values” that, in turn, are converted to light change identifiers that are recognizable by the light tracking system (see FIGS. 4, 8, and corresponding text for further details).

FIG. 8 is a flowchart showing steps taken in converting a sensor's light intensity values to light change identifiers that are processed by a light tracking system. Processing commences at 800, whereupon processing retrieves conversion values from values store 805 at step 810. The conversion values may associate light intensity value limits light change identifiers. For example, light intensity values between 20 candlepower and 60 candlepower correspond to a candlelight identifier, and light intensity values between 180 candlepower and 320 candlepower correspond to an intense light identifier. Values store 805 may be stored on a nonvolatile storage area, such as a computer hard drive.

At step 820, processing monitors the light intensity values from sensor 420 based upon the digital content that is displayed on display 410. Display 410 and sensor 420 are the same as that shown in FIG. 4. A determination is made as to whether there is a change in the light intensity values (decision 830). For example, the light intensity values may be “five” candlepower for an evening scene on a movie, and jump to 250 candlepower during a lightning storm on the movie. If there is not a change in the light intensity values, decision 830 branches to “No” branch 832 which loops back to continue to monitor sensor 420's light intensity values. This looping continues until processing detects a change in the light intensity values, at which point decision 830 branches to “Yes” branch 838.

At step 840, processing uses the retrieved conversion values to convert the light intensity value to a light change identifier, such as those shown in FIG. 5B. Processing, at step 850, provides the light change identifier to light tracking system 110, which processes and adjusts environmental lights accordingly. In one embodiment, the mechanism to convert sensor 420's light intensity values are included in light tracking system 110. Light tracking system 110 is the same as that shown in FIG. 1.

A determination is made as to whether to continue to monitor light intensity values (e.g., a movie continues to play) (decision 860). If processing should continue to monitor light intensity values, decision 860 branches to “Yes” branch 862 which loops back to continue to monitor sensor 420's light intensity values. This looping continues until processing should terminate, at which point decision 860 branches to “No” branch 868 whereupon processing ends at 870.

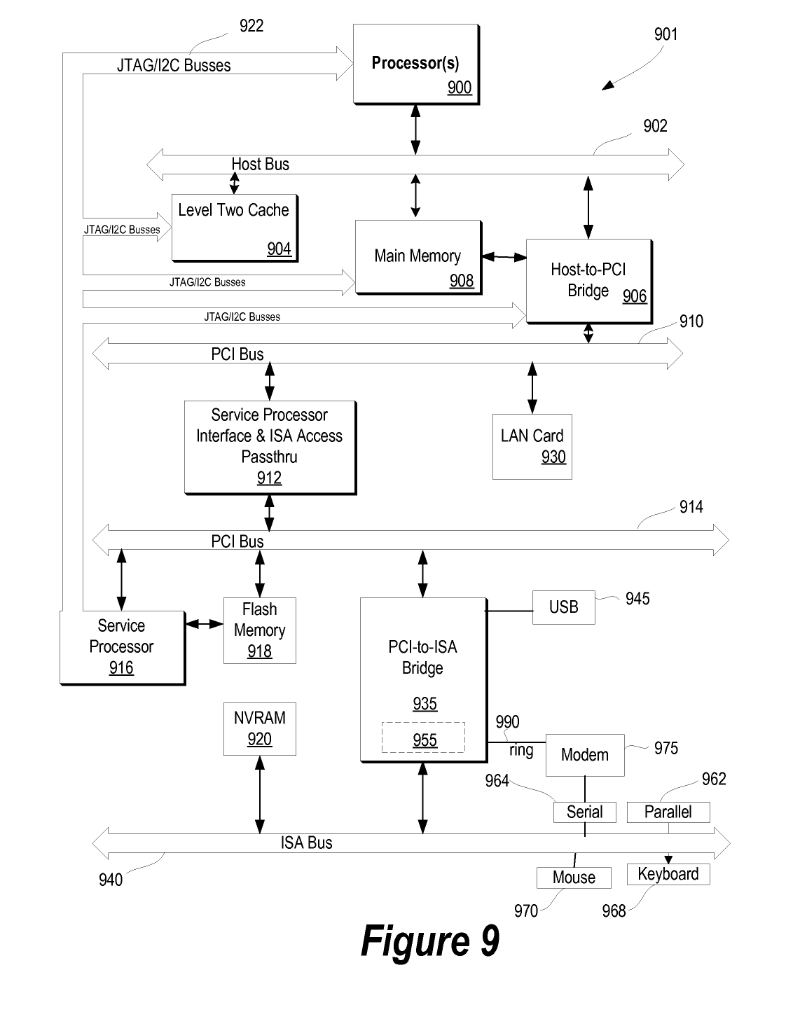

FIG. 9 illustrates information handling system 901 which is a simplified example of a computer system capable of performing the computing operations described herein.

Computer system 901 includes processor 900 which is coupled to host bus 902. A level two (L2) cache memory 904 is also coupled to host bus 902. Host-to-PCI bridge 906 is coupled to main memory 908, includes cache memory and main memory control functions, and provides bus control to handle transfers among PCI bus 910, processor 900, L2 cache 904, main memory 908, and host bus 902. Main memory 908 is coupled to Host-to-PCI bridge 906 as well as host bus 902. Devices used solely by host processor(s) 900, such as LAN card 930, are coupled to PCI bus 910. Service Processor Interface and ISA Access Pass-through 912 provides an interface between PCI bus 910 and PCI bus 914. In this manner, PCI bus 914 is insulated from PCI bus 910. Devices, such as flash memory 918, are coupled to PCI bus 914. In one implementation, flash memory 918 includes BIOS code that incorporates the necessary processor executable code for a variety of low-level system functions and system boot functions.

PCI bus 914 provides an interface for a variety of devices that are shared by host processor(s) 900 and Service Processor 916 including, for example, flash memory 918. PCI-to-ISA bridge 935 provides bus control to handle transfers between PCI bus 914 and ISA bus 940, universal serial bus (USB) functionality 945, power management functionality 955, and can include other functional elements not shown, such as a real-time clock (RTC), DMA control, interrupt support, and system management bus support. Nonvolatile RAM 920 is attached to ISA Bus 940. Service Processor 916 includes JTAG and I2C busses 922 for communication with processor(s) 900 during initialization steps. JTAG/I2C busses 922 are also coupled to L2 cache 904, Host-to-PCI bridge 906, and main memory 908 providing a communications path between the processor, the Service Processor, the L2 cache, the Host-to-PCI bridge, and the main memory. Service Processor 916 also has access to system power resources for powering down information handling device 901.

Peripheral devices and input/output (I/O) devices can be attached to various interfaces (e.g., parallel interface 962, serial interface 964, keyboard interface 968, and mouse interface 970 coupled to ISA bus 940. Alternatively, many I/O devices can be accommodated by a super I/O controller (not shown) attached to ISA bus 940.

In order to attach computer system 901 to another computer system to copy files over a network, LAN card 930 is coupled to PCI bus 910. Similarly, to connect computer system 901 to an ISP to connect to the Internet using a telephone line connection, modem 995 is connected to serial port 964 and PCI-to-ISA Bridge 935.

While FIG. 9 shows one information handling system that employs processor(s) 900, the information handling system may take many forms. For example, information handling system 901 may take the form of a desktop, server, portable, laptop, notebook, or other form factor computer or data processing system. Information handling system 901 may also take other form factors such as a personal digital assistant (PDA), a gaming device, ATM machine, a portable telephone device, a communication device or other devices that include a processor and memory.

One of the preferred implementations of the invention is a client application, namely, a set of instructions (program code) in a code module that may, for example, be resident in the random access memory of the computer. Until required by the computer, the set of instructions may be stored in another computer memory, for example, in a hard disk drive, or in a removable memory such as an optical disk (for eventual use in a CD ROM or DVD) or floppy disk (for eventual use in a floppy disk drive), or downloaded via the Internet or other computer network. Thus, the present invention may be implemented as a computer program product for use in a computer. In addition, although the various methods described are conveniently implemented in a general purpose computer selectively activated or reconfigured by software, one of ordinary skill in the art would also recognize that such methods may be carried out in hardware, in firmware, or in more specialized apparatus constructed to perform the required method steps.

While particular embodiments of the present invention have been shown and described, it will be obvious to those skilled in the art that, based upon the teachings herein, that changes and modifications may be made without departing from this invention and its broader aspects. Therefore, the appended claims are to encompass within their scope all such changes and modifications as are within the true spirit and scope of this invention. Furthermore, it is to be understood that the invention is solely defined by the appended claims. It will be understood by those with skill in the art that if a specific number of an introduced claim element is intended, such intent will be explicitly recited in the claim, and in the absence of such recitation no such limitation is present. For non-limiting example, as an aid to understanding, the following appended claims contain usage of the introductory phrases “at least one” and “one or more” to introduce claim elements. However, the use of such phrases should not be construed to imply that the introduction of a claim element by the indefinite articles “a” or “an” limits any particular claim containing such introduced claim element to inventions containing only one such element, even when the same claim includes the introductory phrases “one or more” or “at least one” and indefinite articles such as “a” or “an”; the same holds true for the use in the claims of definite articles.

What is claimed is:

1. A computer-implemented method comprising:
displaying a video signal on a display;
receiving a light change identifier that identifies a change in light that is synchronized to the video signal;
determining, based upon the light change identifier, a light setting to adjust environmental lighting, the environmental lighting located in proximity to the display; and
adjusting the environmental lighting to the determined light setting.

2. The method of claim 1 wherein the light change identifier is included in a light control track that resides on the same medium as a video track that generates the video signal.

3. The method of claim 2 further comprising:
determining that the light change identifier is a lower light identifier that corresponds to the beginning of the video signal, the adjusting resulting in lowering the environmental lighting in response to the lower light identifier;
detecting a subsequent light change identifier included in the light control track that is a raise light identifier that corresponds to the end of the video signal; and
performing the adjusting again that results in raising the environmental lighting in response to the raise light identifier.

4. The method of claim 2 further comprising:
retrieving light control configuration settings from a storage device;
detecting that the light control configuration settings include a full lighting effect setting; and
determining that the light change identifier is a candlelight identifier that is associated with a scene change in the video signal, the adjusting resulting in dimming the environmental lighting in response to the candlelight identifier.

5. The method of claim 4 further comprising:
determining that the light change identifier is an intense light identifier that is associated with a scene change in the video signal, the adjusting resulting in intensifying the environmental lighting in response to the intense light identifier.

6. The method of claim 1 further comprising:
receiving, from a sensor in proximity to the display, a light intensity value that corresponds to the displayed video signal; and
converting the light intensity value to the light change identifier.

7. The method of claim 1 wherein the environmental lighting corresponds to a light kit that includes a plurality of lights, the adjusting resulting in changing the light intensity of one or more of the plurality of lights.

8. A computer program product stored on a computer operable media, the computer operable media containing instructions for execution by a computer, which, when executed by the computer, cause the computer to implement a method to control environmental lighting, the method comprising:
displaying a video signal on a display;
receiving a light change identifier that identifies a change in light that is synchronized to the video signal;
determining, based upon the light change identifier, a light setting to adjust environmental lighting, the environmental lighting located in proximity to the display; and
adjusting the environmental lighting to the determined light setting.

9. The computer program product of claim 8 wherein the light change identifier is included in a light control track that resides on the same medium as a video track that generates the video signal.

10. The computer program product of claim 9 wherein the method further comprises:
determining that the light change identifier is a lower light identifier that corresponds to the beginning of the video signal, the adjusting resulting in lowering the environmental lighting in response to the lower light identifier;
detecting a subsequent light change identifier included in the light control track that is a raise light identifier that corresponds to the end of the video signal; and
performing the adjusting again that results in raising the environmental lighting in response to the raise light identifier.

11. The computer program product of claim 9 wherein the method further comprises:
retrieving light control configuration settings from a storage device;
detecting that the light control configuration settings include a full lighting effect setting; and
determining that the light change identifier is a candlelight identifier that is associated with a scene change in the video signal, the adjusting resulting in dimming the environmental lighting in response to the candlelight identifier.

12. The computer program product of claim 11 wherein the method further comprises:
determining that the light change identifier is an intense light identifier that is associated with a scene change in the video signal, the adjusting resulting in intensifying the environmental lighting in response to the intense light identifier.

13. The computer program product of claim 8 wherein the method further comprises:
receiving, from a sensor in proximity to the display, a light intensity value that corresponds to the displayed video signal; and
converting the light intensity value to the light change identifier.

14. The computer program product of claim 8 wherein the environmental lighting corresponds to a light kit that includes a plurality of lights, the adjusting resulting in changing the light intensity of one or more of the plurality of lights.

15. An information handling system comprising:
one or more processors;
a memory accessible by the processors;
one or more nonvolatile storage devices accessible by the processors; and
an environmental lighting control tool for controlling environmental lighting, the environmental lighting control tool being effective to:
display a video signal on a display;
receive a light change identifier from one of the nonvolatile storage devices that identifies a change in light that is synchronized to the video signal;
determine, based upon the light change identifier, a light setting to adjust environmental lighting, the environmental lighting located in proximity to the display; and
adjust the environmental lighting to the determined light setting.

16. The information handling system of claim 15 wherein the light change identifier is included in a light control track that resides on the same medium as a video track that generates the video signal.

17. The information handling system of claim 16 wherein the environmental lighting control tool is further effective to:
determine that the light change identifier is a lower light identifier that corresponds to the beginning of the video signal, the adjusting resulting in lowering the environmental lighting in response to the lower light identifier;
detect a subsequent light change identifier included in the light control track that is a raise light identifier that corresponds to the end of the video signal; and
perform the adjusting again that results in raising the environmental lighting in response to the raise light identifier.

18. The information handling system of claim 16 wherein the environmental lighting control tool is further effective to:
retrieve light control configuration settings from one of the nonvolatile storage devices;
detect that the light control configuration settings include a full lighting effect setting; and
determine that the light change identifier is a candlelight identifier that is associated with a scene change in the video signal, the adjusting resulting in dimming the environmental lighting in response to the candlelight identifier.

19. The information handling system of claim 18 wherein the environmental lighting control tool is further effective to:
determine that the light change identifier is an intense light identifier that is associated with a scene change in the video signal, the adjusting resulting in intensifying the environmental lighting in response to the intense light identifier.

20. The information handling system of claim 15 wherein the environmental lighting control tool is further effective to:
receive, from a sensor in proximity to the display, a light intensity value that corresponds to the displayed video signal; and
convert the light intensity value to the light change identifier.
